(19) United States
(12) Patent Application Publication
(10) Pub. No.: US 2022/0299787 A1
(43) Pub. Date: Sep. 22, 2022

(54) SENSING DEVICE

(71) Applicant: InnoLux Corporation, Miao-Li County (TW)

(72) Inventors: Ming-Huang CHEN, Miao-Li County (TW); Hsiao-Feng LIAO, Miao-Li County (TW); I-An YAO, Miao-Li County (TW); Chuan-Chi CHIEN, Miao-Li County (TW)

(73) Assignee: InnoLux Corporation, Miao-Li County (TW)

(21) Appl. No.: 17/676,800

(22) Filed: Feb. 21, 2022

(30) Foreign Application Priority Data
Mar. 19, 2021 (CN) 202110297084.X

(51) Int. Cl. G02B 27/30; G02B 5/00; G06V 40/13

(52) U.S. Cl. CPC G02B 27/30; G02B 5/005; G06V 40/1318

(57) ABSTRACT

A sensing device includes a first substrate, a second substrate disposed opposite to the first substrate, a light source emitting a first light to the object, and a light collimating structure disposed between the first substrate and the second substrate and including a plurality of light shielding layers, wherein the plurality of light shielding layers include a first light shielding layer and a second light shielding layer. The first light shielding layer includes first light transmitting region(s). The second light shielding layer includes second light transmitting region(s). The sensing device includes a sensing structure disposed between the first substrate and the second substrate, and receiving a second light reflected by the object via the first light transmitting region(s) and the second light transmitting region(s). A first width of the first light transmitting region (s) is different from a second width of the second light transmitting region(s).

### CROSS REFERENCE TO RELATED APPLICATION

This application claims the benefit of China Patent Application No. 202110297084.X, filed on Mar. 19, 2021, the entire content of which is incorporated herein by reference.

### BACKGROUND OF THE DISCLOSURE

### 1. Field of the Disclosure

The present disclosure relates to a sensing device, and more particularly to a sensing device for improving an accuracy of recognition.

### 2. Description of the Prior Art

With a technological development of electronic products, a function of fingerprint recognition is integrated into various electronic products and is widely used. Taking a display device such as a smart phone as an example, a user may directly manage the display device via the fingerprint recognition without memorizing a password. A process of the fingerprint recognition is fast, and is not easy to be counterfeited. Thus, the fingerprint recognition provides good convenience or security.

In general, in the existing display device incorporating the function of the fingerprint recognition, an optical sensing device with a light collimating structure may be an example for converting a light reflected by an object into a collimated light, to improve an accuracy of object recognition. However, how to reduce interference of an external stray light via the light collimating structure to improve an effect of the fingerprint recognition is still a problem to be continuously solved in the industry.

### SUMMARY OF THE DISCLOSURE

The present disclosure therefore provides a sensing device and a manufacturing method for manufacturing the sensing device to solve the abovementioned problem.

The present disclosure provides a sensing device for sensing an object. The sensing device includes a first substrate; a second substrate disposed opposite to the first substrate; a light source emitting a first light to the object; a light collimating structure disposed between the first substrate and the second substrate and including a plurality of light shielding layers, wherein the plurality of light shielding layers include a first light shielding layer and a second light shielding layer, the first light shielding layer includes at least one first light transmitting region, and the second light shielding layer includes at least one second light transmitting region; and a sensing structure disposed between the first substrate and the second substrate, and receiving a second light reflected by the object via the at least one first light transmitting region and the at least one second light transmitting region; wherein a first width of the at least one first light transmitting region is different from a second width of the at least one second light transmitting region.

The present disclosure further provides a manufacturing method for manufacturing a sensing device for sensing an object. The manufacturing method includes following steps: providing a first substrate; providing a second substrate disposed opposite to the first substrate; providing a light source emitting a first light to the object; disposing a light collimating structure between the first substrate and the second substrate and including a plurality of light shielding layers, wherein the plurality of light shielding layers include a first light shielding layer and a second light shielding layer, the first light shielding layer includes at least one first light transmitting region, and the second light shielding layer includes at least one second light transmitting region; and disposing a sensing structure between the first substrate and the second substrate, and receiving a second light reflected by the object via the at least one first light transmitting region and the at least one second light transmitting region; wherein a first width of the at least one first light transmitting region is different from a second width of the at least one second light transmitting region.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 is a schematic diagram of a sensing device according to some embodiments of the present disclosure.

FIG. 2 is a schematic diagram of a sensing device according to some embodiments of the present disclosure.

FIG. 3 is a schematic diagram of a sensing device according to some embodiments of the present disclosure.

FIG. 4 is a schematic diagram of a sensing device according to some embodiments of the present disclosure.

FIG. 5 is a schematic diagram of a sensing device according to some embodiments of the present disclosure.

FIG. 6 is a schematic diagram of an anti-stray light structure according to some embodiments of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of a display device in this disclosure, and certain elements in various drawings may not be drawn to scale. In addition, the number and dimension of each device shown in drawings are only illustrative and are not intended to limit the scope of the present disclosure.

Certain terms are used throughout the description and following claims to refer to particular components. As one skilled in the art will understand, electronic equipment manufacturers may refer to a component by different names. This document does not intend to distinguish between components that differ in name but not function.

In the following description and in the claims, the terms “include”, “comprise” and “have” are used in an open-ended fashion, and thus should be interpreted to mean “include, but not limited to . . . ”.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present disclosure. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

It will be understood that, when the corresponding component such as layer or area is referred to “on another component”, it may be directly on this another component, or other component (s) may exist between them (indirect case). On the other hand, when the component is referred to “directly on another component (or the variant thereof)”, any component does not exist between them. “electrically connected to” another element or layer can be directly electrically connected to the other element or layer, or intervening elements or layers may be presented. The terms of “jointed” and “connected” may also include cases where both structures are movable or both structures are fixed.

The terms “equal”, or “same” generally mean within 20% of a given value or range, or mean within 10%, 5%, 3%, 2%, 1%, or 0.5% of a given value or range.

Although terms such as first, second, third, etc., may be used to describe diverse constituent elements, such constituent elements are not limited by the terms. These terms are used only to discriminate a constituent element from other constituent elements in the specification, and these terms have no relation to the manufacturing order of these constituent components. The claims may not use the same terms, but instead may use the terms first, second, third, etc. with respect to the order in which an element is claimed. Accordingly, in the following description, a first constituent element may be a second constituent element in a claim.

It will be understood that, according to some embodiments of the present disclosure, a width of each of elements, a thickness of the each of elements, a height of the each of elements, an area of the each of elements, or a distance or a gap between the elements may be measured by an optical microscopy (OM), a scanning electron microscope (SEM), a film thickness profilometer (α-step), an ellipsometer, or other suitable ways. In detail, according to some embodiments, the SEM may be used for obtaining a cross-sectional structure image of the each of the elements, and to measure the width, the thickness, the height, the area of the each of elements, or to measure the distance, or the gap between the elements.

It should be noted that the technical features in different embodiments described in the following can be replaced, recombined or mixed with one another to constitute another embodiment without departing from the spirit of the present disclosure.

In general, ways to improve an accuracy of object recognition may include geometric optics, diffractive optics and one-dimensional photonic crystals. The geometrical optics may utilize characteristics of a straight forward of a light and a reflective of the light. For example, a light collimating structure may be disposed to adjust a direction of the light. The diffractive optics may utilize characteristics of a diffractive lens structure being thinner than a refractive lens, a thickness being similar to a wavelength, and may be easy to manufacture, to form a light collimating structure to collimate the light. The one-dimensional photonic crystals may utilize the principle of the one-dimensional photonic crystals to form a light collimating structure to collimate the light via periodically arranging multiple layers of thin film structures with different refractive indexes (e.g., dielectric bi-layer multiplayer), wherein the thin film structures may be disposed on a cover glass (CG), a color filter (CF) substrate, or a thin film transistor (TFT) substrate.

The present disclosure applies the geometric optics incorporating a semiconductor manufacturing process widely used in manufacturing electronic products, to form a light collimating structure to collimate a light, which is recited subsequently. For example, for a light collimating structure for collimating the light formed via the geometrical optics, it usually has a high aspect ratio (e.g., 4:1) and is difficult to be realized in a display device manufacturing process. However, for a light collimating structure for collimating a light formed via designing widths (e.g., diameters) of light transmitting regions, the number of light shielding layers and an arrangement of the light shielding layers, it may reduce a view-angle of light receiving to reduce a depth of the light collimating structure, and may further be applied to, for example, a display device with a sensing function, to improve an effect of recognition, for example, to further improve an effect of fingerprint recognition.

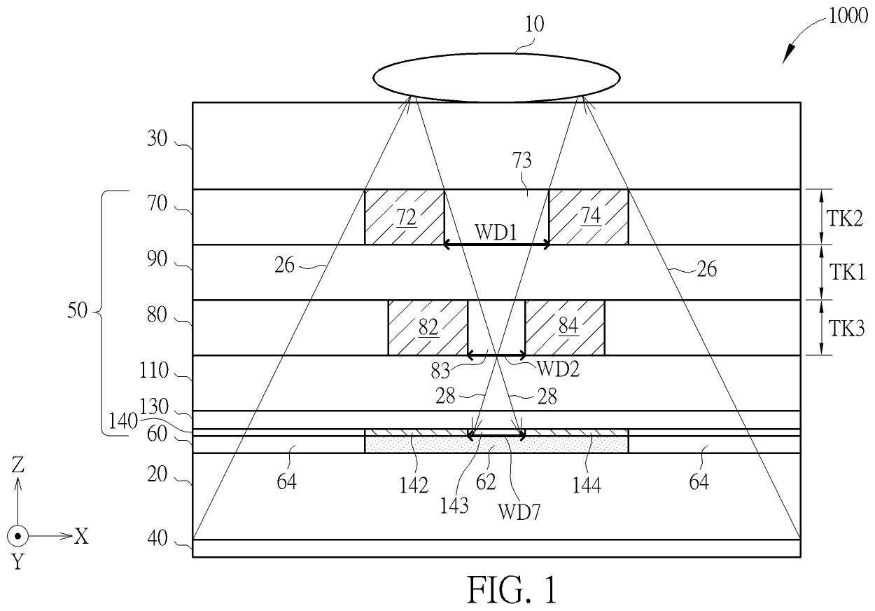

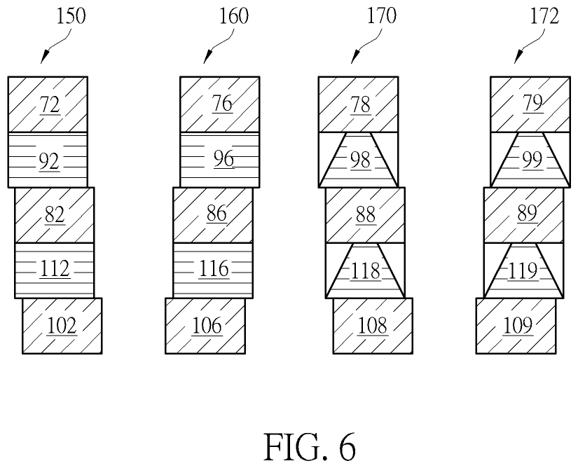

FIG. 1 to FIG. 5 are schematic diagrams of a sensing device 1000 according to some embodiments of the present disclosure, and FIG. 6 is a schematic diagram of an anti-stray light structure according to some embodiments of the present disclosure. The sensing device 1000 may be used for sensing an object 10. The sensing device 1000 includes a first substrate 20, a second substrate 30, a light source 40, a light collimating structure 50 and a sensing structure 60. The second substrate 30 is disposed opposite to the first substrate 20. The light source 40 emits a first light 26 to the object 10. The light collimating structure 50 is disposed between the first substrate 20 and the second substrate 30, and includes a plurality of light shielding layers. The plurality of light shielding layers include a first light shielding layer 70 and a second light shielding layer 80. The first light shielding layer 70 includes a first light transmitting region 73, and the second light shielding layer 80 includes a second light transmitting region 83. The sensing structure 60 is disposed between the first substrate 20 and the second substrate 30. The sensing structure 60 receives (e.g., collects or senses) a second light 28 reflected by the object 10 via the first light transmitting region 73 and the second light transmitting region 83. A first width WD1 of the first light transmitting region 73 may be different from a second width WD2 of the second light transmitting region 83.

In some embodiments, the second light shielding layer 80 is disposed between the sensing structure 60 and the first light shielding layer 70. The first light shielding layer 70 and the second light shielding layer 80 may include a plurality of light shielding regions, which may be materials with lower light transmittance, such as metal (e.g., Copper, Nickel, Aluminum or Titanium), non-metal (e.g., black matrix (BM) or metal oxide (e.g., Alumina))), any other suitable materials, or combinations thereof, but is not limited thereto. The first light shielding layer 70 and the second light shielding layer 80 may reduce interference of a stray light (e.g., sunlight or other light which does not come from the light source 40) or may block a light from passing through, to realize an effect of light shielding, but is not limited thereto.

As shown in FIG. 1, X axis, Y axis and Z axis are perpendicular to each other, wherein the Z axis is a normal direction of the first substrate 20. The light transmitting region of the light shielding layer is disposed between two adjacent light shielding regions. The light transmitting region and the light shielding regions are disposed along the X axis, but is not limited thereto. For example, the first light shielding layer 70 includes a first light shielding region 72 and a second light shielding region 74, and the second light shielding layer 80 includes a third light shielding region 82 and a fourth light shielding region 84. The first light transmitting region 73 formed between the first light shielding region 72 and the second light shielding region 74 is disposed opposite to the second light transmitting region 83 formed between the third light shielding region 82 and the fourth light shielding region 84, and the first width WD1 of the first light transmitting region 73 is larger than the second width WD2 of the second light transmitting region 83. That is, the light collimating structure 50 for collimating the light is formed via increasing the first width WD1 (i.e., increasing alight entering region of the second light 28 reflected by the object 10), it can reduce the view-angle of the light receiving to reduce the depth of the light collimating structure 50. In some embodiments, the first width WD1 may be 6 micrometer (μm), and the second width WD2 may be 4 μm, but is not limited thereto. The width referred to in the present disclosure is a distance from the bottom of one side of the element or region to the bottom of the other side of the element or region along the X axis. For example, the first width WD1 is the distance from the bottom of one side of the first light shielding region 72 close to the second light shielding region 74 to the bottom of one side of the second light shielding region 74 close to the first light shielding region 72 along the X axis.

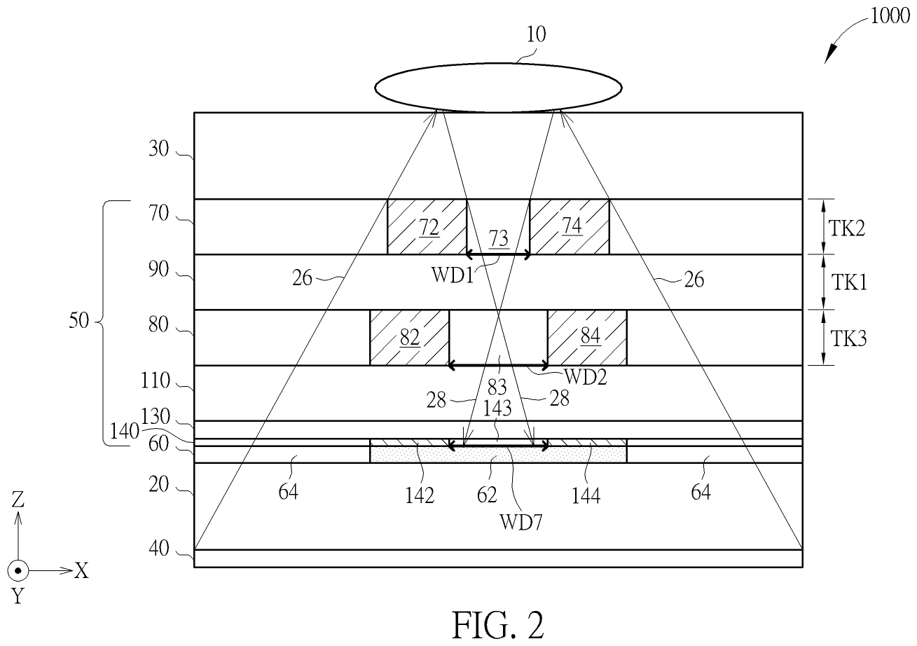

As shown in FIG. 2, the first light shielding layer 70 includes the first light shielding region 72 and the second light shielding region 74, and the second light shielding layer 80 includes the third light shielding region 82 and the fourth light shielding region 84. The first width WD1 of the first light transmitting region 73 formed between the first light shielding region 72 and the second light shielding region 74 is smaller than the second width WD2 of the second light transmitting region 83 formed between the third light shielding region 82 and the fourth light shielding region 84. That is, the light collimating structure 50 for collimating light is formed via increasing the second width WD2 (i.e., increasing (e.g., effective) a width and an area of light receiving of a light receiving area 62 of the sensing structure 60), and it can reduce the view-angle of the light receiving to reduce the depth of the light collimating structure 50. In some embodiments, the first width WD1 may be 4 μm, and the second width WD2 may be 6 μm, but is not limited thereto.

In some embodiments, the light collimating structure 50 may include a first insulating layer 90, which is disposed between the first light shielding layer 70 and the second light shielding layer 80. The first insulating layer 90 may include materials with a higher light transmittance and/or materials which may be used for forming a thick film layer, such as an over coat (OC), a color resist, any other suitable materials, or combinations thereof, but is not limited thereto. A first thickness TK1 of the first insulating layer 90 is smaller than or equal to one of a second thickness TK2 of the first light shielding layer 70 and a third thickness TK3 of the second light shielding layer 80. In some embodiments, the second thickness TK2 may be 3 μm, the third thickness TK3 may be 3 μm, and the first thickness TK1 may be 2 μm, but is not limited thereto. The thickness referred to in the present disclosure is a distance from the bottom of the element or region to the top of the element or region along the Z axis. For example, the first thickness TK1 is the distance from one side of the first insulating layer 90 close to the second light shielding layer 80 to one side of the first insulating layer 90 close to the first light shielding layer 70 along the Z axis.

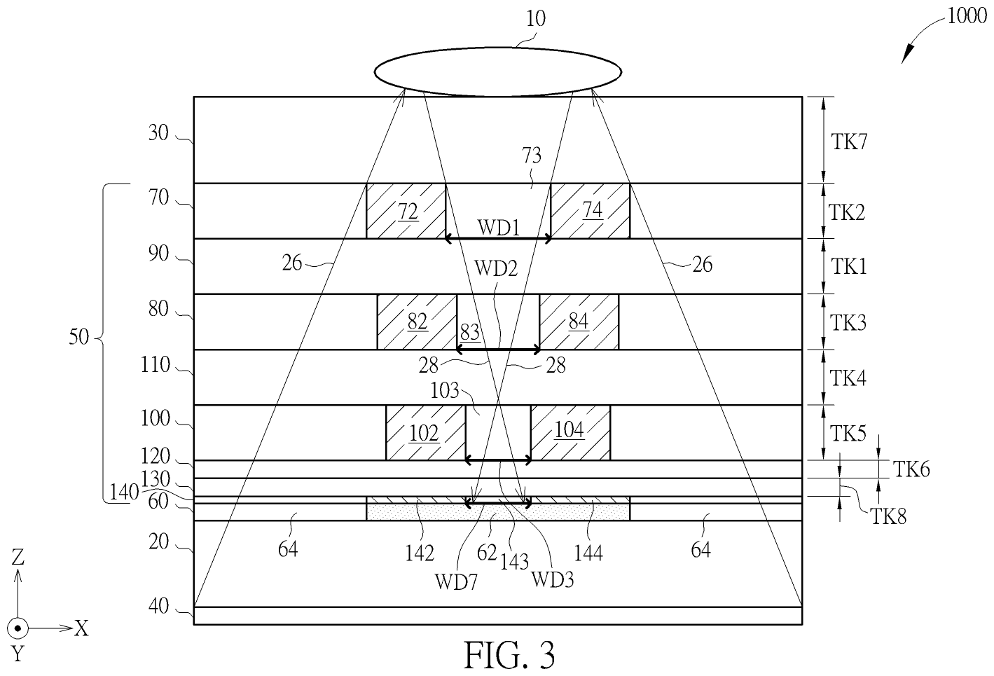

In some embodiments, the sensing device 1000 may further include a third light shielding layer 100, which is disposed between the sensing structure 60 and the second light shielding layer 80. The third light shielding layer 100 may include a plurality of light shielding regions, which may be materials with lower light transmittance, such as metal (e.g., Copper, Nickel, Aluminum or Titanium), non-metal (e.g., BM or metal oxide (e.g., Alumina)), any other suitable materials, or combinations thereof, but is not limited thereto. The third light shielding layer 100 may reduce the interference of the stray light or may block the light from passing through, to realize the effect of the light shielding, but is not limited thereto. The material of the third light shielding layer 100 and the material of the first light shielding layer 70 may be the same or different. The material of the third light shielding layer 100 and the material of the second light shielding layer 80 may be the same or different. As shown in FIG. 3, the third light shielding layer 100 includes a fifth light shielding region 102 and a sixth light shielding region 104. A third light transmitting region 103 formed between the fifth light shielding region 102 and the sixth light shielding region 104 is disposed opposite to the first light transmitting region 73 and the second light transmitting region 83, and a third width WD3 of the third light transmitting region 103 may be different from the first width WD1. The third width WD3 may be different from the second width WD2. In some embodiments, the first width WD1 is larger than the second width WD2, and the second width WD2 is larger than the third width WD3. In some embodiments, the first width WD1 is smaller than the second width WD2, and the second width WD2 is smaller than the third width WD3. That is, the light collimating structure 50 for collimating the light is formed via stacking a plurality of light shielding layers, it can reduce the view-angle of the light receiving to reduce the depth of the light collimating structure 50.

In some embodiments, the light collimating structure 50 may further include a second insulating layer 110, which is disposed between the second light shielding layer 80 and the third light shielding layer 100. The second insulating layer 110 may include materials with a higher light transmittance and/or materials which may be used for forming a thick film layer, such as an OC, a color resist, any other suitable materials, or combinations thereof, but is not limited thereto. The material of the second insulating layer 110 and the material of the first insulating layer 90 may be the same or different. A fourth thickness TK4 of the second insulating layer 110 may be smaller or equal to a thickness of one of the third thickness TK3 and a fifth thickness TK5 of the third light shielding layer 100. In some embodiments, the light collimating structure 50 may further include a third insulating layer 120, which is disposed between the third light shielding layer 100 and the sensing structure 60. The third insulating layer 120 may include materials with a higher light transmittance and/or materials which may be used for forming a thick film layer, such as an OC, a color resist, any other suitable materials, or combinations thereof, but is not limited thereto. The material of the third insulating layer 120 and the material of the first insulating layer 90 may be the same or different. The material of the third insulating layer 120 and the material of the second insulating layer 110 may be the same or different. A sixth thickness TK6 of the third insulating layer 120 may be smaller or equal to the fifth thickness TK5.

In some embodiments, the first width WD1 may be 6 μm, the second width WD2 may be 4 μm, and a width of the light receiving of the light receiving area 62 of the sensing structure 60 may be 2 μm, but is not limited thereto. A seventh thickness TK7 of the second substrate 30 may be 800 μm, but is not limited thereto. A resolution of the sensing structure 60 may be 400 pixels per inch (ppi), but is not limited thereto. The second thickness TK2 may be 3 μm, the first thickness TK1 may be 2 μm, the third thickness TK3 may be 3 μm, the forth thickness TK4 may be 2 μm, the fifth thickness TK5 may be 3 μm, and the sixth thickness TK6 may be 1 μm, but is not limited thereto. In some embodiments, the light collimating structure 50 may further include a cell gap 130. An eighth thickness TK8 of the cell gap 130 may be 3 μm, but is not limited thereto. In the situations of the above light shielding layers and their arrangements, a depth of the light collimating structure 50 (i.e., the sum of the first thickness TK1 to the sixth thickness TK6 and the eighth thickness TK8) may be 17 μm, and the ratio of the depth of the light collimating structure 50 to the first width WD1 is 17:6 (the ratio is less than 4), such that the light collimating structure 50 has a high aspect ratio. That is, the design of the light collimating structure with the high aspect ratio may be realized on the display device with the sensing function via the existing display device manufacturing process and the above disposal, and the effect of the fingerprint recognition is further improved.

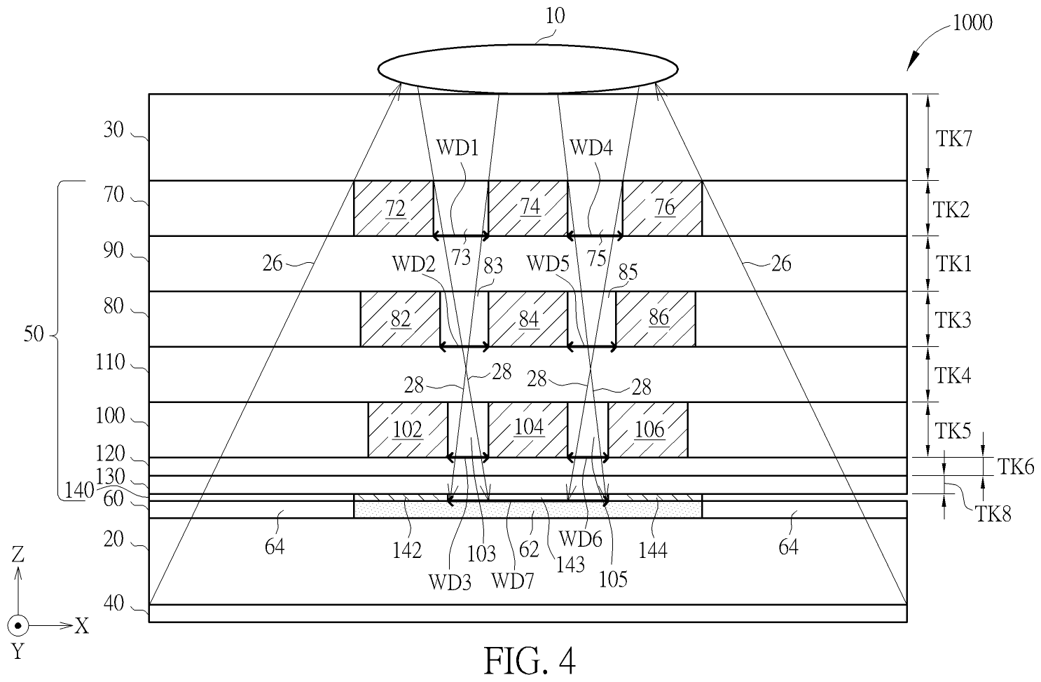

In some embodiments, the first light shielding layer 70 may further include a seventh light shielding region 76. A fourth light transmitting region 75 is formed between the seventh light shielding region 76 and the second light shielding region 74. The second light shielding layer 80 may further include an eighth light shielding region 86. A fifth light transmitting region 85 is formed between the eighth light shielding region 86 and the fourth light shielding region 84. The third light shielding layer 100 may further include a ninth light shielding region 106. A sixth light transmitting region 105 is formed between the ninth light shielding region 106 and the sixth light shielding region 104. The fourth light transmitting region 75, the fifth light transmitting region 85, or the sixth light transmitting region 105 are disposed opposite to each other, and a sixth width WD6 of the sixth light transmitting region 105 may be different from a fourth width WD4 of the fourth light transmitting region 75. The sixth width WD6 may be different from a fifth width WD5 of the fifth light transmitting region 85. In some embodiments, the fourth width WD4 is larger than the fifth width WD5, and the fifth width WD5 is larger than the sixth width WD6. In some embodiments, the fourth width WD4 is smaller than the fifth width WD5, and the fifth width WD5 is smaller than the sixth width WD6. That is, the light collimating structure 50 for collimating the light is formed via stacking a plurality of light shielding layers, it can reduce the view-angle of the light receiving to reduce the depth of the light collimating structure 50. As shown in FIG. 4, the light source 40 emits the first light 26 to the object 10. When the object 10 is placed on the second substrate 30, the sensing structure 60 receives the second light 28 reflected by the object 10 via a first hole formed by the first light transmitting region 73, the second light transmitting region 83, and the third light transmitting region 103. The sensing structure 60 receives the second light 28 reflected by the object 10 via a second hole formed by the fourth light transmitting region 75, the fifth light transmitting region 85, and the sixth light transmitting region 105. That is, the light collimating structure 50 for collimating the light is formed by increasing light receiving holes (i.e., increasing the width and the area of the light receiving of the light receiving area 62 of the sensing structure 60), it can reduce the view-angle of the light receiving to reduce the depth of the light collimating structure 50, to improve the effect of the light collimating.

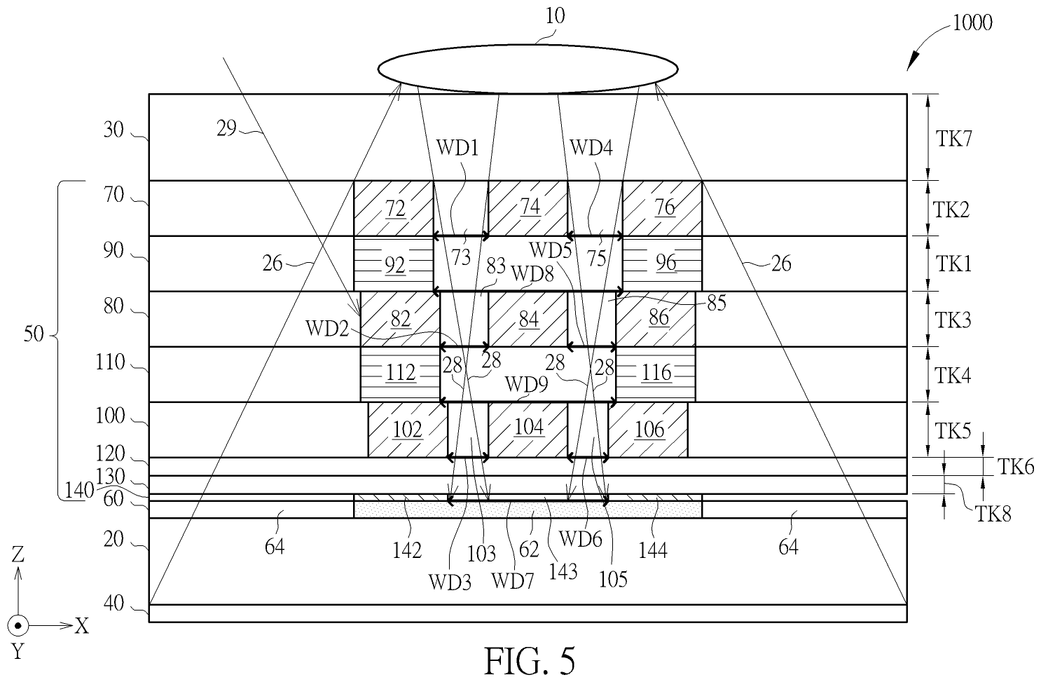

In some embodiments, the stray light is reflected by at least one light shielding layer to the sensing structure 60 without an anti-stray light structure. It is easy to saturate the sensing structure 60, and it is difficult for the sensing structure 60 to receive the second light 28 reflected by the object 10 via the light transmitting regions. In some embodiments, the first insulating layer 90 and/or the second insulating layer 110 may be patterned (e.g., dug) with at least one hole, and may be filled with a non-transparent material (e.g., BM) to form the anti-stray light structure, to block the stray light. As shown in FIG. 5, the first insulating layer 90 is patterned with a hole and is filled with the non-transparent material to form a first anti-stray light structure 92, the second insulating layer 110 is patterned with a hole and is filled with the non-transparent material to forma second anti-stray light structure 112, the first insulating layer 90 is patterned with a hole and is filled with the non-transparent material to form a third anti-stray light structure 96, and the second insulating layer 110 is patterned with a hole and filled with the non-transparent material to form a fourth anti-stray light structure 116. The light source 40 emits the first light 26 to the object 10, and a stray light 29 is reflected by the object 10. When the object 10 is placed on the second substrate 30, in the situation that the first anti-stray light structure 92 and the second anti-stray light structure 112 are disposed, the stray light 29 is blocked such that it is difficult to be reflected to the sensing structure 60 via the at least one light shielding layer. As a result, the sensing structure 60 may receive the second light 28 reflected by the object 10 without (or with reduced) interference of the stray light 29.

In some embodiments, the first light shielding region 72, the first anti-stray light structure 92, the third light shielding region 82, the second anti-stray light structure 112, and the fifth light shielding region 102 may form an anti-stray light structure 150. In some embodiments, the anti-stray light structure 150 in FIG. 5 may be implemented as an anti-stray light structure 170 in FIG. 6. In some embodiments, the seventh light shielding region 76, the third anti-stray light structure 96, the eighth light shielding region 86, the fourth anti-stray light structure 116 and the ninth light shielding region 106 may form an anti-stray light structure 160. In some embodiments, the anti-stray light structure 160 in FIG. 5 may be implemented as an anti-stray light structure 172 in FIG. 6.

In some embodiments, the light collimating structure 50 may further include a fourth light shielding layer 140, which is disposed between the sensing structure 60 and the cell gap 130. The fourth light shielding layer 140 may include a plurality of light shielding regions, which may be materials with lower light transmittance, such as metal (e.g., Copper, Nickel, Aluminum or Titanium), non-metal (e.g., BM or metal oxide (e.g., Alumina)), any other suitable materials, or combinations thereof, but is not limited thereto. The fourth light shielding layer 140 may reduce the interference of the stray light or may block the light from passing through, to realize the effect of the light shielding, but is not limited thereto. The material of the fourth light shielding layer 140 and the material of the first light shielding layer 70 may be the same or different. The material of the fourth light shielding layer 140 and the material of the second light shielding layer 80 may be the same or different. The material of the fourth light shielding layer 140 and the material of the third light shielding layer 100 may be the same or different. In some embodiments, the fourth light shielding layer 140 may include a tenth light shielding region 142 and a eleventh light shielding region 144. A seventh light transmitting region 143 is formed between the tenth light shielding region 142 and the eleventh light shielding region 144. In some embodiments, a thickness of the fourth light shielding layer 140 is equal to or smaller than any thickness of the first thickness TK1 to the eighth thickness TK8. For example, the thickness of the fourth light shielding layer 140 may be 1 μm, but is not limited thereto.

As shown in FIG. 1, the seventh light transmitting region 143 is disposed opposite to the first light transmitting region 73 and the second light transmitting region 83. A seventh width WD7 of the seventh light transmitting region 143 may be smaller than the first width WD1, and may be equal to or smaller than the second width WD2. It can reduce the view-angle of the light receiving to reduce the depth of the light collimating structure 50, to improve the effect of the light collimating. As shown in FIG. 2, the seventh light transmitting region 143 is disposed opposite to the first light transmitting region 73 and the second light transmitting region 83. The seventh width WD7 may be larger than the first width WD1, and may be equal to or larger than the second width WD2. It can reduce the view-angle of the light receiving to reduce the depth of the light collimating structure 50, to improve the effect of the light collimating. As shown in FIG. 3, the seventh light transmitting region 143 is disposed opposite to the first light transmitting region 73, the second light transmitting region 83 and the third light transmitting region 103. The seventh width WD7 may be smaller than the first width WD1 and the second width WD2, and may be the same or smaller than the third width WD3. It can reduce the view-angle of the light receiving to reduce the depth of the light collimating structure 50, to improve the effect of the light collimating. In some embodiments, the seventh width WD7 may be equal to the width of the light receiving of the light receiving area 62.

As shown in FIG. 5, the seventh light transmitting region 143 is disposed opposite to the first light transmitting region 73, the second light transmitting region 83, the third light transmitting region 103, the fourth light transmitting region 75, the fifth light transmitting region 85 and the sixth light transmitting region 105. A eighth width WD8 is a distance from the bottom of one side of the first anti-stray light structure 92 close to the third anti-stray light structure 96 to the bottom of the one side of the third anti-stray light structure 96 close to the first anti-stray light structure 92 along the X axis. A ninth width WD9 is a distance from the bottom of one side of the second anti-stray light structure 112 close to the fourth anti-stray light structure 116 to the bottom of the one side of the fourth anti-stray light structure 116 close to the second anti-stray light structure 112 along the X axis. The seventh width WD7 may be smaller than the eighth width WD8, and may be equal to or smaller than the ninth width WD9. It can reduce the view-angle of the light receiving to reduce the depth of the light collimating structure 50, to improve the effect of the light collimating.

In FIG. 1 to FIG. 5, the first light 26 is illustrated as a part of paths of the first light 26, and lights emitted to the object 10 via the light source 40 may all belong to the first light 26 in the embodiments of the present disclosure. The second light 28 is illustrated as a part of paths of the second light 28. Lights pass through the first light transmitting region 73, the second light transmitting region 83, and/or the third light transmitting region 103, and the seventh light transmitting region 143, and reflected by the object 10 and received by the sensing structure 60 may all belong to the first light 28 in the embodiments of the present disclosure. In FIG. 4 and FIG. 5, the second light 28 is illustrated as a part of paths of the second light 28. Lights pass through the fourth light transmitting region 75, the fifth light transmitting region 85, and/or the sixth light transmitting region 105, and the seventh light transmitting region 143, and reflected by the object 10 and received by the sensing structure 60 may all belong to the first light 28 in the embodiments of the present disclosure. In FIG. 5, the stray light 29 is illustrated as a part of paths of the stray light 29. Stray Lights pass through the second substrate 30 may all belong to the stray light 29 in the embodiments of the present disclosure.

In some embodiments, the sensing device 1000 may be an electronic device including the sensing structure 60 or a display device including the sensing structure 60, but is not limited thereto. The electronic device may be a bendable electronic device or a flexible electronic device. The electronic device may include, for example, a liquid crystal light emitting diode. The light emitting diode may include, for example, an organic light emitting diode (OLED), a sub-millimeter light emitting diode (mini LED), a micro LED or a quantum dot light emitting diode (quantum dot (QD), e.g., QLED, QDLED), fluorescence, phosphor, or other suitable materials. The materials may be arranged and combined arbitrarily, but is not limited thereto.

In some embodiments, the object 10 may be a finger. When a finger is placed on the second substrate 30, the first light 26 emitted by the light source 40 to the finger is reflected by the finger to the sensing structure 60 with the second light 28. When peaks and valleys of a fingerprint of the finger reflect the light, the second light 28 received by the sensing structure 60 includes light and dark contrast stripes to form a fingerprint image, which may be used for the fingerprint recognition. In some embodiments, the object 10 may be a laser pointer or a pen.

In some embodiments, the first substrate 20 may be an array substrate. In some embodiments, the first substrate 20 may include a polarizer, a TFT substrate, a capacitor, a TFT, and an integrated circuit (IC), an indium-tin oxide (ITO) pixel electrode, or combination thereof. In some embodiments, the first substrate 20 may be a color filter array substrate (COA), but is not limited thereto.

In some embodiments, the second substrate 30 may include a protective layer, an optically clear adhesive (OCA), a polarizing plate, a CF substrate, a CF, an ITO common electrode, or combination thereof. In some embodiments, the second substrate 30 may not include a CF, but is not limited thereto. A material of the substrate referred to in the present disclosure includes a rigid substrate, a flexible substrate, or combination thereof. For example, the first substrate 20 or the second substrate 30 may include glass, quartz, sapphire, acrylic resin, polycarbonate (PC), polyimide (PI), polyethylene terephthalate (PET), other suitable transparent materials, or combination thereof, but is not limited thereto.

In some embodiments, the light source 40 may include a direct type backlight unit (BLU), a side-light type BLU or a self-luminous BLU, but is not limited thereto.

In some embodiments, the sensing structure 60 may include the light receiving area 62 and a flat area 64. In some embodiments, the light receiving area 62 may include an optical sensor or other suitable sensor. In some embodiments, the light receiving area 62 may include a photodiode or may include a PIN diode or a NIP diode having an undoped intrinsic semiconductor region between the p-type semiconductor and the n-type semiconductor. In some embodiments, the light receiving area 62 may receive the second light 28, and may convert the received second light 28 into a current signal. In some embodiments, the light receiving area 62 may be used for the fingerprint recognition. In some embodiments, materials of the flat area 64 may include organic materials, inorganic materials, other suitable transparent materials, or combination thereof, but is not limited thereto. For example, the inorganic materials may include silicon nitride, silica, silicon oxynitride, Alumina, other suitable transparent materials, or combination thereof, but is not limited thereto. For example, the organic materials may include epoxy resins, silicone, acrylic resins (e.g., polymethylmetacrylate (PMMA)), polyimide, perfluoroalkoxy alkane (PFA), other suitable transparent materials, or combination thereof, but is not limited thereto. In some embodiments, the flat area 64 may include materials with a higher light transmittance and/or materials which may be used for forming a thick film layer, such as an OC, a color resist, other suitable materials, or combination thereof, but is not limited thereto.

It is noted that, the term “FIG. 1 to FIG. 5” in each of the above embodiments indicates that the range includes FIG. 1, FIG. 5 and other figures in between. The term “the first thickness TK1 to the sixth thickness TK6” in each of the above embodiments indicates that the range includes the first thickness TK1, the sixth thickness TK6 and other thicknesses in between. The term “the first thickness TK1 to the eighth thickness TK8” in each of the above embodiments indicates that the range includes the first thickness TK1, the eighth thickness TK8 and other thicknesses in between.

It is noted that, the technical features in above embodiments can be replaced, recombined or mixed with one another to constitute another embodiment without departing from the spirit of the present disclosure.

To sum up, in the sensing device of the present disclosure, the light collimating structure for collimating the light is formed by designing the widths of light transmitting regions, the number of the light shielding layers and the arrangements of the light shielding layers, it can reduce the view-angle of the light receiving to reduce the depth of the light collimating structure, to improve the accuracy of the object recognition. As a result, the problem that it is difficult to realize the light collimating structure with the high aspect ratio in the existing display device manufacturing process can be solved.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A sensing device for sensing an object, comprising:
a first substrate;
a second substrate disposed opposite to the first substrate;
a light source emitting a first light to the object;
a light collimating structure disposed between the first substrate and the second substrate and comprising a plurality of light shielding layers, wherein the plurality of light shielding layers comprise a first light shielding layer and a second light shielding layer, the first light shielding layer comprises at least one first light transmitting region, and the second light shielding layer comprises at least one second light transmitting region; and
a sensing structure disposed between the first substrate and the second substrate, and receiving a second light reflected by the object via the at least one first light transmitting region and the at least one second light transmitting region;
wherein a first width of the at least one first light transmitting region is different from a second width of the at least one second light transmitting region.

2. The sensing device of claim 1, wherein the second light shielding layer is disposed between the sensing structure and the first light shielding layer, and the first width is larger than the second width.

3. The sensing device of claim 1, wherein the second light shielding layer is disposed between the sensing structure and the first light shielding layer, and the first width is smaller than the second width.

4. The sensing device of claim 1, wherein the light collimating structure further comprises an insulating layer, and the insulating layer is disposed between the first light shielding layer and the second light shielding layer.

5. The sensing device of claim 4, wherein a first thickness of the insulating layer is smaller than or equal to a second thickness of one of the first light shielding layer and the second light shielding layer.

6. A manufacturing method for manufacturing a sensing device for sensing an object, comprising following steps:
providing a first substrate;
providing a second substrate disposed opposite to the first substrate;
providing a light source emitting a first light to the object;
disposing a light collimating structure between the first substrate and the second substrate and comprising a plurality of light shielding layers, wherein the plurality of light shielding layers comprise a first light shielding layer and a second light shielding layer, the first light shielding layer comprises at least one first light transmitting region, and the second light shielding layer comprises at least one second light transmitting region; and
disposing a sensing structure between the first substrate and the second substrate, and receiving a second light reflected by the object via the at least one first light transmitting region and the at least one second light transmitting region;
wherein a first width of the at least one first light transmitting region is different from a second width of the at least one second light transmitting region.

7. The manufacturing method of claim 6, wherein the second light shielding layer is disposed between the sensing structure and the first light shielding layer, and the first width is larger than the second width.

8. The manufacturing method of claim 6, wherein the second light shielding layer is disposed between the sensing structure and the first light shielding layer, and the first width is smaller than the second width.

9. The manufacturing method of claim 6, wherein the light collimating structure further comprises an insulating layer, and the insulating layer is disposed between the first light shielding layer and the second light shielding layer.

10. The manufacturing method of claim 9, wherein a first thickness of the insulating layer is smaller than or equal to a second thickness of one of the first light shielding layer and the second light shielding layer.
